(19) United States
(12) Patent Application Publication
(10) Pub. No.: US 2026/0362299 A1
(43) Pub. Date: Nov. 12, 2026

(54) ENHANCED MEMBER WTRU SELECTION ASSISTANCE CONSIDERING THE ENERGY SAVING INDICATOR

(71) Applicant: InterDigital Patent Holdings, Inc., Wilmington, DE (US)

(72) Inventors: Achref Methenni, Montreal (CA); Michael Starsinic, Newtown, PA (US); Saad Ahmad, Montreal (CA)

(73) Assignee: InterDigital Patent Holdings, Inc., Wilmington, DE (US)

(21) Appl. No.: 19/202,876

(22) Filed: May 8, 2025

(51) Int. Cl. H04W 48/16; H04W 52/02

(52) U.S. Cl. CPC H04W 48/16; H04W 52/02

(57) ABSTRACT

A network device may be configured to receive, from an application function (AF), a request for wireless transmit/receive (WTRU) selection assistance, a list of WTRU candidates, and/or energy saving indication (ESI) filtering criteria. The network device may send, to a unified data management function (UDM), the list of WTRU candidates subject to energy saving, and/or a request for information indicating one or more ESI capable WTRUs from the list of WTRU candidates. An ESI capable WTRU may have ESI information as part of its subscription data. The network device may receive, from the UDM, a message indicating a plurality of ESI capable WTRUs from the list of WTRU candidates. The NEF may determine a subset of ESI capable WTRUs from the plurality of ESI capable WTRUs based on the ESI filtering criteria. The NEF may send an indication of the subset of ESI capable WTRUs to the AF.

### BACKGROUND

The 5GS may provide support to application functions for selecting a wireless/transmit receive unit (WTRU) according to certain criteria. An application function (AF) may send a request to the 5GS, via the network exposure function (NEF), that may includes an initial UE list and/or filtering criteria. The filtering criteria may include quality of service (QOS) parameters, service experience, and/or WTRU location, etc.

The NEF may authorize the AF request. The NEF may map the AF request to services that the NEF needs to perform to obtain UE information and/or perform member WTRU selection assistance. The NEF may then interact with different network functions, depending on the filtering criteria included by the AF, and/or obtain information related to WTRUs in the initial WTRU list.

The NEF may then consolidates the received information, and/or determine a list of WTRU candidates. WTRU candidates are the WTRU candidates to be used by the AF. The NEF then provides the list of WTRU candidate the AF, with potentially additional information.

In 5GS, an energy saving indicator (ESI) may be defined to reflect information related the UE is subject to energy savings. The ESI may be part of the WTRU subscription information stored at the unified data management (UDM). ESI may be obtained by an access and mobility management function (AMF) and/or forwarded to other network functions such as a policy control function (PCF) and a radio access network (RAN), to potentially consider it for energy saving purposes SUMMARY A network device may be configured to receive, from an application function (AF), a request for wireless transmit/receive (WTRU) selection assistance, a list of WTRU candidates subject to energy savings, and/or energy saving indication (ESI) filtering criteria. The network device may send, to a unified data management function (UDM), the list of WTRU candidates, and/or a request for information indicating one or more ESI capable WTRUs from the list of WTRU candidates. An ESI capable WTRU may be a WTRU candidate that has ESI information associated with its subscription data. The network device may receive, from the UDM, a message indicating a plurality of ESI capable WTRUs from the list of WTRU candidates. The NEFmay determine a subset of ESI capable WTRUs from the plurality of ESI capable WTRUs based on the ESI filtering criteria. The NEFmay send an indication of the subset of ESI capable WTRUs to the AF.

The network device may receive, from a user plane function (UPF), information associated with a state of an ESI. The network device may determine an updated subset of ESI capable WTRUs based on the information associated with the state of the ESI. The network device may send the updated subset of ESI capable WTRUs to the AF.

The ESI filtering criteria may comprise one or more of an indication of WTRUs currently in an ESI state, an indication of a ratio of WTRUs currently in an ESI active or ESI inactive state, an indication of percentage values of WTRUs currently under which ESI state to be selected, time value for a duration of a protocol data unit (PDU) in an ESI state, and/or an occurrence value for the percentage of one or more PDU sessions in an ESI state.

The request for WTRU selection assistance may comprise an indication of an energy saving level. The ESI capable WTRU may be associated with a time value. The time value may represent the duration the ESI capable WTRU is subject to energy saving. The ESI capable WTRU may be associated with a location value. The location value may represent one or more geographic areas where the ESI capable WTRU is subject to energy saving.

The network device may send, to the AF, a notification message. The notification message may indicate that the list of WTRU candidates subject to energy saving or that the subset of ESI capable WTRUs is no longer valid and/or needs updating. The notification message may further indicate that the list of WTRU candidates subject to energy saving or that the subset of ESI capable WTRUs is no longer valid due to a change in the state of the ESI.

The message indicating a plurality of ESI capable WTRUs from the list of WTRU candidates may further indicate one or more time validity conditions or one or more spatial validity conditions. The network device comprises a network exposure function (NEF).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 shows an example procedure for member wireless transmit/receive unit (WTRU) selection assistance considering energy saving indicator (ESI) as filtering criteria.

FIG. 3 shows an example procedure of member WTRU selection assistance with dynamic ESI information and/or ESI state monitoring.

FIG. 4 shows an example procedure of WTRU selection assistance procedure based on ESI related statistics and/or procedures.

### DETAILED DESCRIPTION

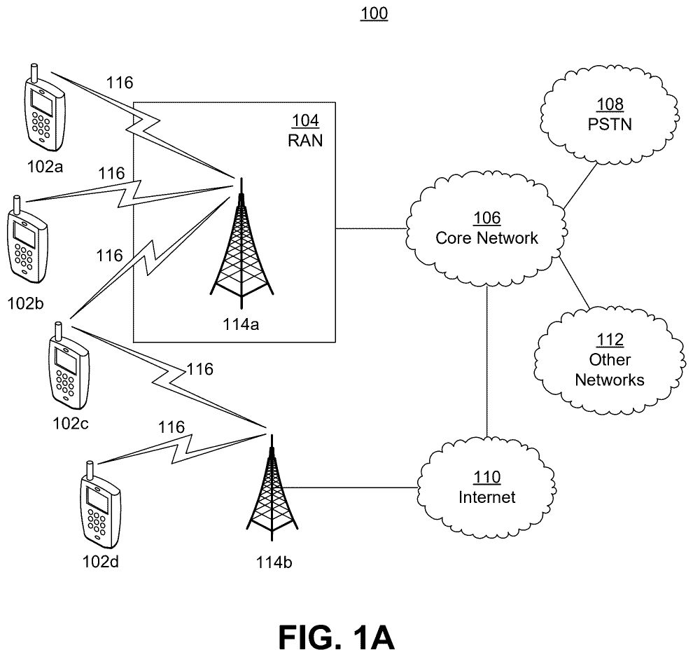

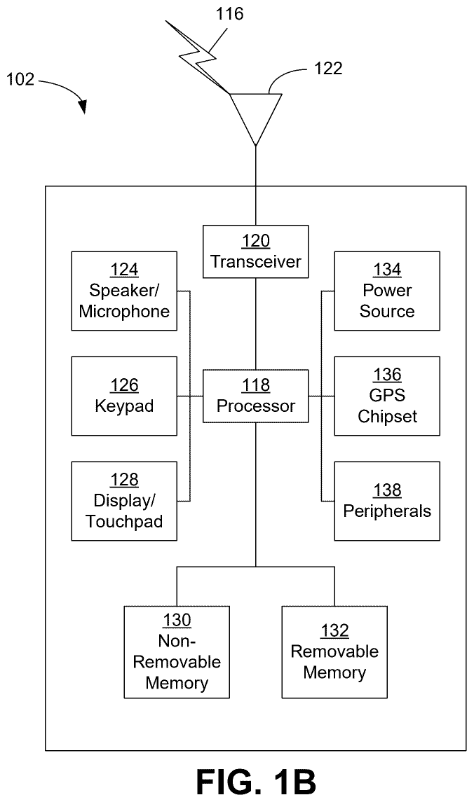

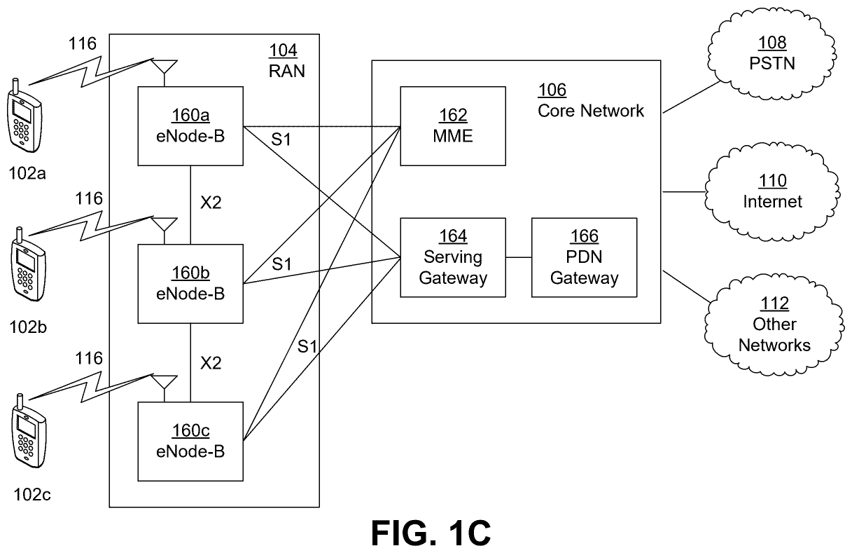

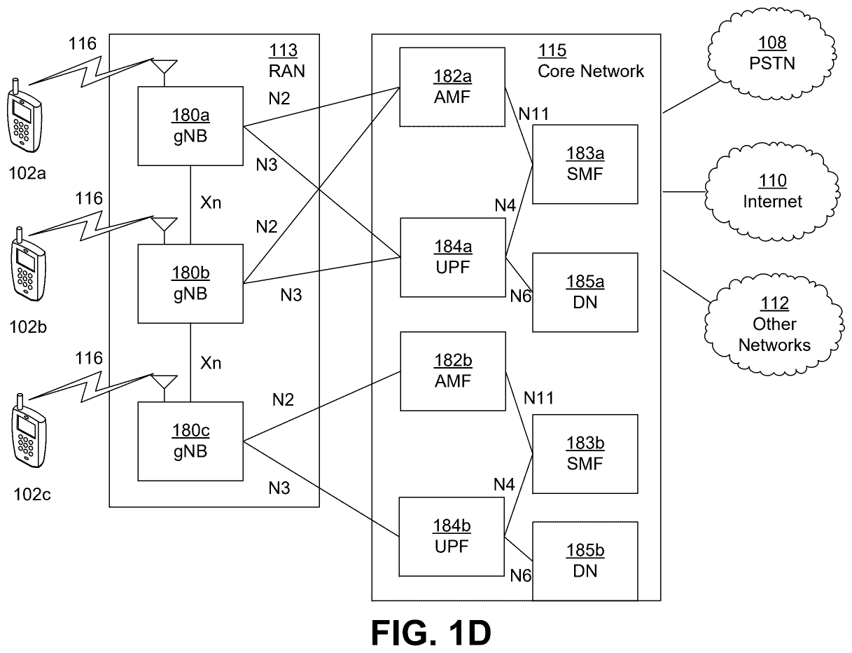

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUS 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A network exposure function (NEF) may receive a request for a member user equipment (UE), also referred to herein as a wireless transmit/receive unit (WTRU), selection assistance information from an application function (AF). The selection assistance information may include a list of WTRUs and energy saving indicator (ESI) related filtering criteria such as requesting WTRUs that support (respectively do not support) ESI and/or a ratio of the WTRUs that support ESI. The NEF may request WTRUs that are currently in, e.g., a certain ESI state 1, and/or a ratio of WTRUs that are currently in an ESI active or inactive state, etc.

The NEF may send a message to the unified data management function (UDM) to request ESI related information for the WTRUs. The NEF may provide a list of WTRUs to the UDM and ESI related info.

The NEF may obtain from the UDM, for each WTRU, data information related to the energy saving indicator for the WTRU. The ESI related information result may include an indication whether the WTRU supports ESI and/or validity conditions for the WTRU ESI. The NEF may determine a list of candidate WTRUs based on ESI, e.g., a list of candidate WTRUs that support ESI.

Then the NEF may request and/or subscribe to information related to current ESI state for the WTRUs and/or protocol data unit (PDU) sessions and/or data traffic of interest.

The NEF may want to know whether the WTRU and/or a certain PDU session of the WTRU may be currently under an active or inactive state. The NEF may also want to subscribe to notifications to changes in current ESI state and/or related information.

The NEF may receive information related to current ESI state and/or related information from the user plane function (UPF). The NEF may determine a list of candidate WTRUs and/or send a response message to the AF, including the candidate WTRU list, and ESI and/or ESI state related information (e.g., ESI state for each WTRU).

The NEF may then receive a notification from the UPF indicating WTRU ESI state change, e.g., that some WTRUs changed their ESI state from “inactive” to “active”. The NEF may then send a notification message to the AF, e.g., to indicate that some WTRU current ESI state has changed. The notification may indicate that the new current ESI state may indicate the candidate WTRU list is no longer valid due to the change in some WTRUs current ESI state. The AF may use this indication to update the initial WTRU list or update the ESI related filtering criteria.

A solution described herein may involve member WTRU selection assistance based on energy saving indicator related information. An NEF may perform the following actions.

First, the NEF may receive a request for member WTRU selection assistance information from an AF. The request may include a list of WTRUs and ESI related filtering criteria. The ESI related filtering criteria may include: requesting WTRUs that may support (respectively do not support) an ESI (e.g., have an ESI as part of their WTRU subscription data); a ratio and/or a percentage of the WTRUs that support ESI; time, duration, or location values where the WTRUs support (resp. do not support) the ESI, if available; requesting WTRUs that are currently in ESI state (e.g., ESI active, ESI inactive, and/or ESI level 1, etc.); a ratio of WTRUs that are currently in an ESI active or inactive state; weighting factors that represent the desired percentage of WTRUs currently under which ESI state to be selected; a time value for the duration of a PDU session and/or data flow has been in a certain ESI state (including an average duration); and/or an occurrence value for the percentage of the WTRU traffic, PDU sessions, and/or data flows are currently under a certain ESI state.

Second, the NEF may authorize the AF request. The NEF may map the external ESI filtering criteria attributes to internal ESI attributes.

Third, the NEF may send a message to the UDM to request ESI related information for the WTRUs. The NEF may provide a list of WTRUs to the UDM and/or request to obtain data from WTRU subscription information related to the data type ESI.

Fourth, the NEF may obtain from the UDM, for each WTRU, data information related to the ESI for the WTRU. The ESI related information result may include: an indication whether the WTRU supports ESI (e.g., an existing ESI field with value “support”, “conditional support”, “not support”, or “empty”); and/or validity conditions for the WTRU support of ESI, (e.g., time of the day or locations where the WTRU supports ESI).

Fifth, the NEF may determine a list of candidate WTRUs based on an ESI, using ESI filtering criteria provided by the AF. For example, the NEF may determine a list of candidate WTRUs that support ESI Sixth, the NEF may determine to obtain information related to the current ESI state and/or information for the WTRUs of interest. The NEF may send a message to the session management function (SMF) that may serve the WTRU to request or subscribe to information related to current ESI state related to WTRU data traffic. The message may indicate: whether the WTRU and/or a certain PDU session of the WTRU is currently under an active or inactive state; whether the WTRU and/or a certain WTRU PDU session is currently under a certain ESI level, (e.g., ESI level 1, ESI level 2, etc.); how long has the WTRU and/or a certain WTRU PDU session have been in a certain ESI level, or in the current ESI level, and/or additionally a threshold value related to this duration; what percentage of WTRU traffic is currently going under a certain ESI state x, and/or for each undergoing ESI state, and/or additionally a threshold value related to this percentage; and/or subscribe to notifications to changes in current ESI state and/or related information.

Seventh, the NEF may receive information related to current ESI state and/or related information from the UPF. The NEF may determine a list of candidate WTRUs based on information received from the UPF and ESI filtering criteria provided by the AF. For example, the candidate WTRU list may include 20% of WTRUs currently in ESI active state and/or 80% of WTRUs currently in ESI inactive state.

Eighth, the NEF may send a response message to the AF. The response message may include the candidate WTRU list, and/or ESI and/or ESI state related information (e.g., ESI state for each WTRU).

Ninth the NEF may receive a notification from the UPF indicating WTRU ESI state change. For example, the notification message may indicate that WTRU1 to WTRU40 changed their ESI state from “inactive” to “active”.

Tenth, the NEF may send a notification message to the AF. The message to the AF may: indicate that some WTRU current ESI state changed, and/or their new current ESI state; indicate the candidate WTRU list is no longer valid due to the change in some WTRUs current ESI state; indicate that the AF may needs to update the initial WTRU list or update the ESI related filtering criteria; and/or include a new list of WTRUs, that are not in the AF initial WTRU list, that may be considered.

The member WTRU selection assistance procedure may enables an application function to request assistance form the core network, e.g., the NEF, to obtain a list of candidate WTRUs. This may be based on an initial WTRU list that the AF provides and/or based on the filtering criteria. The filtering criteria may include quality of service (QOS) criteria, WTRU location related information, and/or access type criteria, etc.

In the system architecture 2, working group (SA2 WG), network energy saving study and/or normative work in release (Rel)-19, a WTRU may have in the WTRU subscription information a new indicator called an energy saving indicator (ESI). The ESI means that the WTRU may be subject to network energy saving.

Currently, the member WTRU selection assistance procedure does not take into consideration the fact that WTRUs may or may not support energy saving via the ESI in the WTRU subscription. An application function may benefit from including such criteria for application services to optimize their application services.

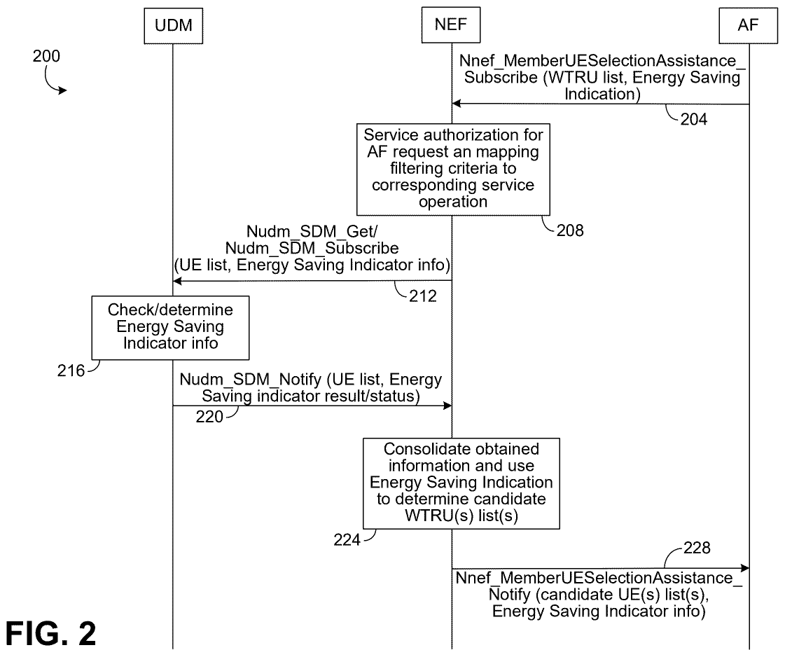

FIG. 2 shows an example procedure 200 for member WTRU selection assistance considering energy saving indicator (ESI) as filtering criteria. At 204, the AF may send a message to the NEF to request member WTRU selection assistance. The AF may use Nnef_MemberUESelectionAssistance_Subscribe service operation. The message from AF may include a list of WTRUs to be considered for the member selection assistance by the network. The AF may further include filtering criteria related to ESI, or shortly ESI filtering criteria.

The AF may be interested in energy saving behavior related to the WTRUs in the WTRU list. The AF ESI may indicate that the AF is interested in WTRUs that subject to network energy saving. The energy saving indication may have a value of “true”, “yes”, “support”, and/or 1, to indicate that the AF is interested in WTRUs subject to energy saving.

The AF may be interested in WTRUs not subject to network energy saving. In this case, the ESI may indicate that only WTRUs that do not support network energy saving are needed. The ESI may have a value of “false”, “no”, “does not support”, and/or 0.

The ESI for the WTRU may be associated with a time value (e.g., time validity criteria). The time value may represent the time window in which the WTRU is authorized to be subject to network energy savings. Outside the time window, the WTRU should not be subject to network energy saving, even if the WTRU supports the energy saving indicator.

The ESI for the WTRU may be associated with a location value (e.g., spatial validity criteria). The location value may be an area of interest, a list of tracking areas, and/or where the WTRU can be subject to network energy saving.

The AF may provide an expected time for the application traffic to exchanged, or a specific area of interest where the WTRU would be. The network may use this time parameter together with the ESI temporal and spatial validity criteria to determine to select WTRUs where the energy saving will be active for the duration of the expected time of application traffic exchange.

The temporal and/or spatial validity criteria may have a certain time and/or duration after which they need to be updated and/or refreshed, called expiry time. For example, if the temporal validity criteria are determined based on some historical data, current data, and/or predictions as well, then the temporal validity criteria may change either periodically or at a certain time. Hence, a network function may use the expiry time to request updated values of the temporal and/or spatial validity criteria.

The AF may indicate a certain ratio for the number of WTRU that support the energy saving indicator (in the WTRUs subscription information) from the total number of WTRUs to be selected as candidate member WTRUS.

For example, the AF may indicate a ratio of 50% indicating that it requests 50% of the WTRUs to support energy saving indication and/or 50% of the WTRUs to not support energy saving indication. In another example, the AF may indicate that it needs only 20% of the WTRUs (that would be part of the candidate WTRU list) to support the energy saving indication.

In case the ESI is associated with different levels and/or behaviors of energy savings (e.g., energy saving level(s) 1, 2, and/or 3), the message from AF may include ESI filtering criteria related to the specific energy saving levels for the WTRUS.

The AF message may indicate that only WTRUs subject to energy saving behavior of values 1 and/or 2 may be selected and/or provided as part of the candidate WTRU list. The AF message may indicate that WTRUs that support energy saving indicator, which may be subject to energy saving level 3,should not be included in the candidate WTRU list.

The AF may provide percentage values and/or weighting factors for the different energy saving levels, (e.g., for the WTRUs in the WTRU list). For example, the AF may request the network (e.g., the NEF) to provide candidate WTRUs, where 50% of the WTRUs go through energy saving level 1, 40% of the WTRUs go through energy saving level 2, and/or 10% of WTRUs go through energy saving level 3.

At 208, once the NEF receives the member WTRU selection assistance request from the AF, the NEF may authorize the AF request. The NEF may also perform a mapping between the filtering criteria provided by the AF and/or corresponding service operation.

In the case of using ESI as filtering criteria, the NEF may map an indication from an AF for a WTRU to support network energy savings, to the WTRU having an ESI as part of the WTRU subscription data. Hence, the NEF may determine to interact with the UDM to obtain such information.

At 212, the NEF may send a message to the UDM to request and/or subscribe to an ESI information for the WTRUs of interest. The NEF may include in the interaction with the UDM the WTRUs provided by the AF in the WTRU list.

The NEF message also includes ESI information. For example, the NEF message may indicate that the NEF wants to obtain the information whether a certain WTRU has the ESI in its subscription data. The NEF may want to know if there are attributes related to the ESI that either are part of the WTRU subscription information or that the NEF needs to obtain (e.g., time validity and/or location validity criteria).

At 216, the UDM may retrieve WTRU ESI related information. The UDM may have a database comprising the subscription information of the WTRU. The UDM may check the database to determine ESI capability for the WTRU in the database. The NEF may use the UDM response for each WTRU and/or consolidate the information based on the filtering provided by the AF. For example, NEF may ask to obtain UDM for the ESI information for WTRU1 to WTRU 10. The UDM may respond that WTRU1 to WTRU5 has ESI support, whereas WTRU6 to WTRU10 do have ESI indicating not supported. In this case, if AF requested NEF to select only UE with ESI support, then the NEF may select WTRU1 to WTRU5.

At 220, the UDM may send to the NEF a response message including WTRU ESI related information. The UDM message may include an indication whether the WTRU subscription data includes an energy saving indicator field. Alternatively, the UDM may provide a field with a default value “0” or “empty” to indicate that a WTRU does not have an ESI in their subscription data. The UDM message may include an indication whether the ESI for WTRU indicates “support” or “no support” for ESI for the WTRU. The UDM message may include ESI related attributes, such as time validity and/or spatial validity conditions for the WTRU (e.g., times of the day, time window, and/or locations where the WTRU supports the ESI).

At 224, once the NEF receives the ESI related information from the UDM for the WTRUs in the WTRU list, the NEF may consolidate the received information and/or determine a candidate WTRU list, according to the AF request (e.g., the ESI filtering criteria).

The NEF may include in the candidate WTRU list only the WTRUs that do not support the ESI. Alternatively, the NEF may include in the candidate WTRU list only the WTRUs that support the ESI. The NEF may include WTRUs in the candidate WTRU list, according to a certain ratio value z and/or percentage value y. The NEF may filter the WTRUs based on the temporal and/or spatial validity condition of the ESI for the WTRUs. For example, NEF may ask to obtain UDM for the ESI information for WTRU1 to WTRU10. The UDM may respond that WTRU1 to WTRU5 has ESI support, whereas WTRU6 to WTRU10 do have ESI indicating not supported. In this case, if AF requested NEF to select WTRU with ESI support, then the NEF will select WTRU1 to WTRU5.

If the AF expects the traffic for the WTRUs to take place at night, then the WTRUs that support ESI at nighttime may not be included in the candidate WTRU list. This may be done to avoid using the WTRUS that may go through network energy saving at night. The WTRUs that do not support the ESI at night may be included in the candidate WTRU list since these WTRUs will not undergo network energy saving when the AF session takes place.

At 228, the NEF may provide the candidate WTRU list to the AF. The NEF may provide additional information related to the ESI information of the WTRU, such as the temporal validity criteria.

A solution described herein may involve member WTRU selection assistance with dynamic ESI information and ESI state monitoring. Described herein is a scenario where the core network may determine information related to ESI based on current and/or real time data from different network functions that serve the WTRU and/or be able to assist the AF with the member WTRU selection procedure.

A WTRU that has an ESI in the WTRU subscription information may be subject to energy savings, yet the WTRU may not necessarily go through energy saving all the time. Depending on the energy saving state, configuration, and/or behavior of the network nodes such as serving radio access network (RAN) and/or serving UPF, and/or depending on the network performance (e.g., whether the network is congested) the WTRU may go through network energy saving.

In this case, the energy saving indication form the AF may relate to whether or not the WTRU is the energy saving for the WTRU is active. The ESI filtering criteria included in the message from AF may indicate the selection of WTRUs that support ESI. The filtering criteria may further indicate for which the energy saving is inactive (e.g., energy saving status has a value of “inactive” for the WTRUs) as candidate WTRUs for the AF session. In other words, the AF may indicate to the NEF to select WTRUs that either do not support ESI, or that support it but for which ESI is not active.

The AF may have interested in WTRUs that support ESI and/or are currently subject to network energy saving by the network nodes (e.g., RAN and/or UPF), e.g., ESI may be active for the WTRU and/or data session. In this case, the ESI filtering criteria from the AF may include an ESI status set to “active”, for example.

The AF message may include in the ESI filtering criteria one or more time threshold values related to how long a WTRU and/or WTRU data session has been in a certain ESI state (e.g., active, inactive, ESI level 1, and/or ESI level 2, etc.).

Similarly to the indication of whether the energy saving is “active” or “inactive”, each energy saving level may be associated with occurrence metrics. Such occurrence metrics may include as how often an energy saving level x applied for the WTRU, for the current data sessions (e.g., PDU sessions).

The ESI state attributes may have different granularities, including per WTRU, per PDU session, and/or per data network name (DNN) and/or single network slice selection assistance information (S-NSSAI).

In case the ESI may be associated with different levels or behaviors of energy savings (e.g., energy saving level 1, 2, and/or 3), the message from AF may include ESI filtering criteria related to the specific energy saving levels for the WTRUs. The AF message may indicate that WTRUs currently undergoing to ESI levels 1 and/or 2 may be selected as candidate WTRUs, where WTRUs currently undergoing ESI level 3 may not be selected. The AF message may indicate that only WTRUs that are subject to energy saving behavior of values 1 and 2 may be selected and/or provided as part of the candidate WTRU list. The AF message may indicate that WTRUs that support energy saving indicator, which may be subject to energy saving level 3, may not be included in the candidate WTRU list.

The AF may provide percentage values or weighting factors for the different energy saving levels for the WTRUs in the WTRU list. For example, the AF may request the network (e.g., the NEF), to provide candidate WTRUs, where 50% of the WTRUs go through energy saving level 1, 40% of the WTRUs go through energy saving level 2, and/or 10% of WTRUs go through energy saving level 3.

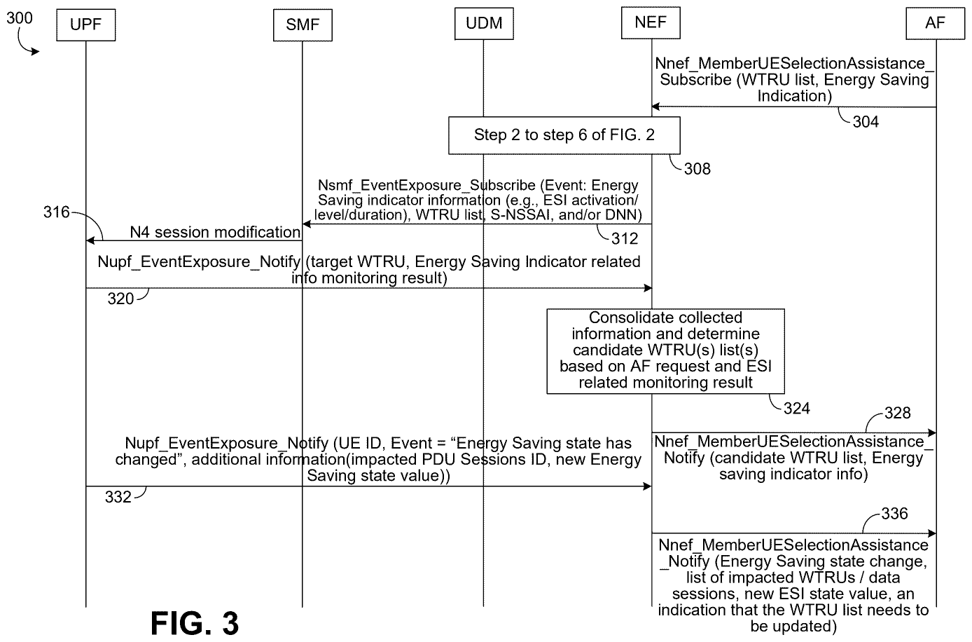

FIG. 3 shows an example procedure 300 of member WTRU selection assistance with dynamic ESI information and/or ESI state monitoring. At 304, the AF may send a member WTRU selection assistance request to the NEF. The AF may include a WTRU list. The AF may also include ESI filtering criteria. The ESI filtering criteria may refer to, in addition to indicating WTRUs that support ESI (as part of their WTRU subscription data): requesting WTRUs currently in ESI state (e.g., ESI active, ESI inactive, and/or ESI level 1, etc.); a ratio of WTRUs currently in an ESI active or inactive state; weighing factors for the percentage of WTRUs currently under which ESI state to be selected; a time value for the duration of a PDU Session has been in a certain ESI state (including an average duration); an occurrence value for the percentage of the WTRU traffic, PDU sessions, and/or data flows currently under a certain ESI state.

At 308, the NEF may perform steps 208 to 224 of FIG. 2. The NEF may request the UDM to provide information related to the WTRUs having energy saving indicator in the WTRU subscription information (e.g., a “ESI capable WTRU”s, wherein an ESI capable WTRU is a WTRU candidate that has ESI information in its subscription data). If there are different values (e.g., ESI levels), the NEF may request what levels are supported for each WTRU.

The NEF may use the ESI related information obtained from the UDM to determine an initial list (e.g., a subset) of candidate WTRUs. If the AF is interested in WTRUs that support ESI (e.g., ESI capable WTRUs), and support energy saving levels 1 and 2, then the NEF may not include WTRUs that do not support the ESI and/or WTRUs that support the ESI but do not support energy saving level 1.

At 312, the NEF may determine to obtain information related to the current ESI state and/or information for the WTRUs of interest. The NEF may use the ESI filtering criteria to determine which information and/or events to request and/or subscribe to. For example, the NEF may send a message to an SMF that serves a certain WTRU, e.g., WTRU1, to request and/or subscribe to information related to ESI state usage related to the WTRU data traffic.

The NEF request may indicate it wants information on the duration in which WTRU1 or a PDU session of WTRU1 has been in a certain ESI state. The NEF message may indicate that the NEF wants to know whether the WTRU and/or a certain PDU session of the WTRU is currently under an active or inactive state. The NEF message may indicate that the NEF wants to know whether the WTRU or a certain WTRU PDU session is currently under a certain ESI level, (e.g., ESI level 1, ESI level 2, etc.) The NEF message may indicate that the NEF wants to know how long the WTRU and/or a certain WTRU PDU session may have been at the certain ESI level and/or at the current ESI level. The NEF message may indicate that the NEF wants to know what percentage of WTRU traffic is currently going under a certain ESI state x, or for each undergoing ESI state.

The NEF may subscribe to notifications to changes in some of the ESI related information the NEF wants to obtain. For example, the NEF may subscribe to a notification when the WTRU ESI state changes to active, or when the WTRU ESI state becomes inactive, and/or when the ESI state is ESI level 1, etc.

At 316, the SMF may be triggered to configure a UPF that serves the WTRU, to monitor ESI state for the WTRU or certain traffic or PDU session of the WTRU, and/or to provide information either to the SMF or directly to the NEF. The SMF may use the parameters provided by the NEF at 312 to determine a suitable configuration for the UPF (e.g., monitoring period, monitored events and information, and/or reporting thresholds).

The information and/or events monitored may not consider energy consumption information. Rather, these events may be related to the ESI and/or the ESI state, e.g., whether the ESI is active or inactive for the WTRU or PDU session or traffic of interest, or whether the ESI state corresponds to a certain ESI level. The ESI level may reflect a certain energy saving behavior.

At 320, the UPF may obtain and/or determine information related to ESI state monitoring as configured by the SMF. The UPF may send ESI state-related information to the NEF, either periodically or when a certain threshold is exceeded. The UPF may then send the ESI state-related information to the NEF. As disclosed herein, an NEF may request for information indicating one or more ESI capable WTRUs from the list of WTRU candidates, wherein an ESI capable WTRU is a WTRU candidate that has ESI information in its subscription data.

The actions, functions, and/or events shown at 312, 316, and/or 320, may involve multiple SMFs that serve the different WTRUs in the WTRU list described at 308, and multiple UPFs that carry or route WTRU data traffic and/or PDU sessions for the different WTRUs. For example, a SMF1 may serve WTRU1 to WTRU5 and/or SMF2 may serve WTRU6 to WTRU10. Additionally, a UPF1 may serve WTRU1 to WTRU3; a UPF2 may serve WTRU4 to WTRU 7, and/or a UPF 3 may serve WTRU 8 to WTRU 10.

The NEF may also interact with other network functions, such as the PCF that serve SM policies for the WTRUs. The NEF may interact with the policy control function (PCF) to obtain information about which ESI states may be configured for the WTRU and/or WTRU traffic. The ESI states may be configured based on policy control charging (PCC) rules that the PCF has.

At 324, the NEF may use the information provided by the UPFs at 320 and/or the request information provided by the AF at 304 to determine updated and/or final candidate WTRU lists (e.g., a subset of ESI capable WTRUs). For example, the NEF may include in the candidate WTRU list only the WTRUs that are currently undergoing network energy saving, hence for which the ESI state is active (e.g., a subset of ESI capable WTRUs). In another example, the NEF may include in the candidate WTRU list the WTRUs that currently have ESI state set to ESI level 1 and ESI level 2. The NEF may select a WTRUS based on a certain weight associated with each WTRU, and/or a certain weight associated with each ESI state, etc.

At 328, the NEF may send a response message to the AF including a candidate WTRU list and/or additional ESI related information. The UPF may detect a change in the ESI state related to a certain WTRU and/or certain data sessions and/or PDU sessions related to the WTRU. For example, the UPF may have initially determined that a certain WTRU (e.g., WTRU1), has an ESI state for the WTRU or for a certain PDU session having the value at “inactive”, meaning the WTRU and/or PDU session or data session for the WTRU did not go through network energy savings (since the ESI state is inactive).

The UPF may detect that the ESI state related to WTRU1, or PDU session of data session for WTRU1, have change the ESI state to “active”. This may mean that the WTRU and/or PDU session or data session for WTRU1 started to undergo network energy saving (e.g., due to energy optimizations and/or energy related congestion at the serving UPF and/or RAN nodes).

At 332, the UPF may send a notification message to the NEF. The UPF may indicate that the ESI state related to the WTRU has changed. The notification from the UPF may include for which granularities the ESI state has changed, e.g., the PDU sessions' data session of interest for which the ESI state has changed. The notification message from the UPF may include the new ESI state related to the WTRU of interest. The NEF may receive one or more notifications from the UPF(s) related to ESI state changes, with ESI state change related information.

At 336, the NEF may use the notification message(s) from the UPF(s) to determine that the candidate WTRU list (e.g., a subset of ESI capable WTRUs) needs to be updated. The AF request message at 304 may have indicated that WTRUs currently not undergoing energy saving have an ESI state set to “inactive”.

At 324, the NEF may have determined to include WTRU1, which had a current ESI state “inactive” and hence included WTRU1 in the candidate WTRU list sent to the AF at 328.

When the NEF receives a notification from UPF that WTRU1 ESI state changed from “inactive” to “active”, the NEF may determine that WTRU1 may no longer be suitable to be in the candidate WTRU list.

The AF request message at 304 may have indicated to include WTRUs with current ESI state being “active” and WTRUs with current ESI state being “inactive”, with a ratio or percentage value of 20% WTRUs in “active ESI state and/or 80% WTRUs in “inactive” ESI state.

At 336, the NEF may receive notification messages for multiple WTRUs that indicate that these WTRUs current ESI state have changed. For example, the NEF may receive indication that WTRU1 to WTRU40, which had an ESI state of “inactive” have their ESI state change to “active” state. Initially, the candidate WTRU list provided by the NEF to the AF at 328 included 200 WTRUs, with 20% of the WTRUs or 40 WTRUs in “active” ESI state, and/or 80% of the WTRUs or 160 WTRUs in “inactive” ESI state.

With the ESI state change notifications received from the UPF at 324, the NEF now determines that 80 WTRUs (or 40% of the WTRUs), from the candidate WTRU list are currently in “active” state and 120 WTRUs (or 60% of the WTRUs) from the candidate WTRU list are currently in “inactive” state. In this case, the NEF may determine that the ratio, weights, and/or percentages of WTRUs from different current ESI states is no longer met. Hence the candidate WTRU list (e.g., subset) may no longer be valid.

At 336, the NEF may send a notification message to the AF. The notification message from the NEF may indicate that the candidate WTRU list (determined by the NEF), or that the initial WTRU list (provided by the AF at 304) may no longer be valid.

The message from the NEF may indicate that the reason for the list being no longer valid is due to the change in ESI states for WTRUs, data sessions, and/or PDU sessions related to the WTRUs. The message from the NEF may include a number of WTRUs with ESI state change. The message from NEF may indicate which WTRUs have their current ESI state change and/or include the new ESI state related to the WTRUs. The message from the NEF may include the number of additional WTRUs needed with a certain ESI state to obtain a suitable candidate for the WTRU list. The message from NEF may indicate that the WTRU list and/or ESI filtering criteria, may need to be updated (e.g., relaxed).

The NEF may obtain information about what new WTRUs that were not included in the initial WTRU list provided by the AF that may be suitable candidate for the AF service (e.g., that march the ESI filtering criteria provided by the AF). In such case, the NEF may include this list of additional WTRUs in the notification message to the AF.

Once the AF receives the notification message from the NEF, the AF may determine to update the WTRU list (e.g., add additional WTRUs) and/or update the ESI related filtering criteria (e.g., relaxing the percentage of WTRUs that have their current ESI state as “active”, hence leveraging more WTRUS undergoing network energy saving).

A solution described herein may involve member WTRU selection assistance based on ESI state related statistics and/or predictions. Described herein is how an application function may request the network (e.g., the NEF) to assist the AF with member WTRU selection. The AF may include energy saving indication that may require predictions and/or estimates about energy saving aspects in a future time.

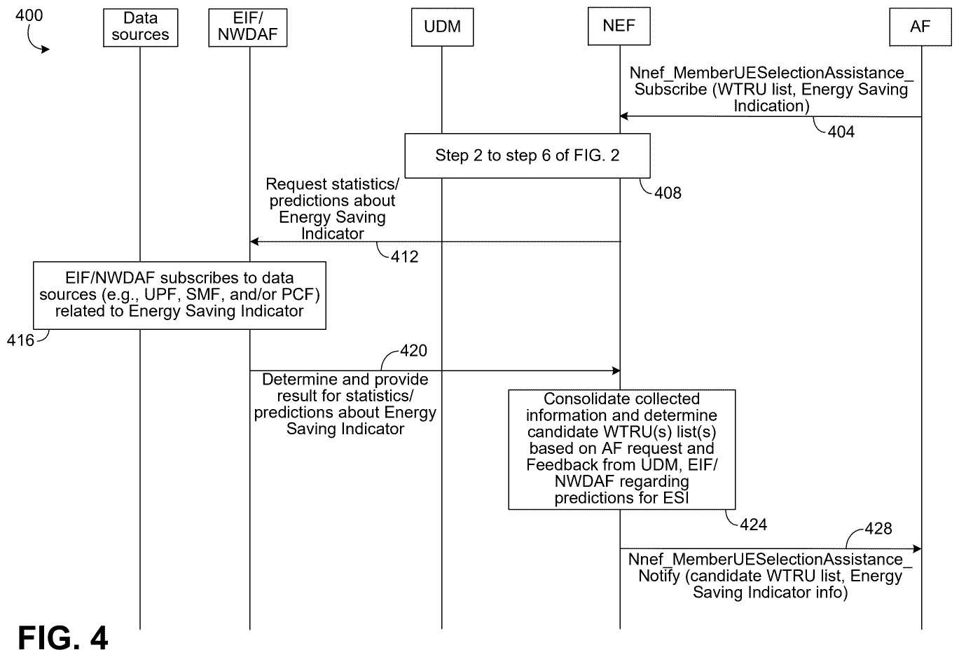

FIG. 4 shows an example procedure 400 of member WTRU selection assistance procedure based on ESI related statistics and/or procedures. At 404, similarly to 204 of FIG. 2, the AF may send a member WTRU selection assistance request to the NEF. The AF may include a WTRU list. The AF may also include ESI information.

When there are attributes related to ESI that may change with time and/or depending on certain conditions, then the network may provide statistics, estimates, and/or predictions related to the energy saving aspects and/or behavior.

Additionally or alternatively, the AF may provide an expected time for the application traffic to be exchanged. The network may use this time parameter together with the ESI indication to select WTRUs where the energy saving may be active for the duration of the expected time of application traffic exchange.

The AF may include may indicate threshold values for ESI state analytics related to the use of the WTRU and/or WTRU traffic undergoing network energy saving. The ESI state analytics may relate to statistics (e.g., frequency) of activation in the past and/or present, and/or a prediction, estimation, and/or probability of activation in a future time (e.g., time when the AF expects that traffic would be exchanged with the WTRU).

The ESI state information may include a time value to refer to the time and/or time window value, when the WTRU energy saving status needs to be “active or “inactive”. For example, the AF may be interested to obtain WTRUs for which ESI is not active a certain time of the day to allow the AF service to not be impacted by the network energy saving. The ESI may indicate a frequency value related to the use of the WTRU and/or WTRU traffic undergoing network energy saving.

The AF may indicate a threshold related to the ESI state statistics for the WTRUs. For example, the AF may indicate that a WTRU that support ESI, may be considered candidate WTRUs, as long as the frequency of ESI activation is low or less than a certain value or percentage (e.g., 0.2 or 20%). In this case, an AF that tries to reduce degradation of data services for the WTRUs may consider both WTRUs that do not support ESI and WTRUs that support ESI but rarely activate or undergo network energy savings based on historical and/or current data.

The AF may indicate a threshold related to the statistics or prediction related to ESI state for the WTRUs. For example, the AF may indicate to the NEF to select WTRUs that have an average ESI activation occurrence of 20%. In another example, the AF may indicate to the NEF to select WTRUs for which the likelihood of ESI activation is below 30%.

The ESI state analytics may be determined for different granularities. For example, an ESI state analytic may refer to a certain occurrence frequency (e.g., a statistic) and/or likelihood (e.g., a prediction) of the UE, a specific traffic or PDU Session of the WTRU going through network energy saving. For example, the ESI activation occurrence may refer to an estimate of the frequency and/or likelihood of the WTRU going through network energy saving, for a specific service type, or DNN/S-NSSAI, and/or application.

In case the energy saving indicator for a WTRU may be associated with different levels and/or behaviors of energy savings (e.g., energy saving level 1, 2, and/or 3), then the message from AF may include information related to the specific energy saving levels for the WTRUs.

The AF may provide different classes and/or categories related to the likelihood that a WTRU would be subject to energy saving, for a certain energy saving level x, for a certain duration, in the future. The AF may provide percentage values or weighting factors for the different energy saving levels, for the WTRUs in the WTRU list. For example, the AF may indicate a maximum or minimum time window and/or duration for which the AF expects certain WTRUs to go through energy savings. The time window threshold may be measured per energy saving level, per WTRU, and/or per group of WTRU. For example, the AF may indicate that it wants WTRUs that spend a minimum of 5 minutes during the AF session in ESI level 1, and at least 1 minute in ESI level 2 during the AF session. Similarly, the AF may indicate a maximum time window and/or duration for which the AF expects certain WTRUs to go through energy savings. The AF may provide a confidence level or accuracy level for the predictions (e.g., high, medium, low confidence/accuracy).

At 408, the NEF may perform steps 208 to 224 of FIG. 2. The NEF may request the UDM to provide information related to the WTRUs having energy saving indicator in the WTRU subscription information. If there are different values (e.g., energy saving levels), the NEF may request what levels are supported for each WTRU.

The NEF may use the ESI related information obtained from the UDM to determine an initial list of candidate WTRUs. For example, if the AF is interested in WTRUs that support the ESI, and support energy saving levels 1 and/or 2, then the NEF may not include WTRUs that do not support the ESI, and/or WTRUs that support the ESI but do not support energy saving level 1.

At 412, based on the request from the AF at 404, the NEF may send a request to a network function to obtain statistics, predictions, and/or analytics related to the ESI.

The NEF message may be sent to an energy information function (EIF) network function (NF) and/or to a network data analytics function (NWDAF) NF. The NEF message may indicate the EIF and/or NWDAF to determine information in terms of statistics and/or predictions for the ESI for the WTRUs in the initial candidate WTRU list, that were determined at 408. The NEF may also provide threshold values related to the statistics and/or predictions to the EIF and/or NWDAF. For example, the NEF may provide the EIF and/or NWDAF with a confidence level and/or accuracy level that the statistics and/or predictions may satisfy.

At 416, the EIF and/or NWDAF may interact with other network functions, such as, e.g., the PCF, SMF, and/or UPF. The EIF and/or NWDAF may interact with these network functions to collect information related to the ESI usage for the WTRUs. The EIF, NWDAF, and/or other NF may keep track of the occurrences when a WTRU that has an ESI did go through network energy savings. For example, a certain WTRU1 may have had in the last 100 data sessions (e.g., PDU sessions), the network energy saving applied to 30 of the 100 WTRU data sessions. Accordingly, WTRU1 may have an energy saving count of 30. WTRU1 may have an average energy saving activation occurrence of 30/100 or 30%. This information and/or occurrence related metrics may be obtained using historical data reflecting how many times the network energy saving was applied to a certain WTRU in a certain period of time in the past. This ESI activation occurrence information may also be based on the current data sessions that the WTRU has established with the network.

At 420, the EIF and/or NWDAF may determine the result for the ESI state analytics (e.g., statistics and/or predictions) for each WTRU. The EIF and/or NWDAF may send the result to the NEF.

At 424, the NEF may consolidate the received statistics and/or predictions results to determine a candidate list for the AF. For example, the NEF may receive information about the predicted duration of a data session in the future, when ESI is active for the WTRU for the data session. The NEF may determine different categories of WTRUs based on this information. For example, the NEF may identify long duration WTRUs that have a large value for the predicted duration of the ESI activation in the future for a data session. Other WTRUs with a short, predicted duration for ESI activation in a future data session may be categorized as short duration WTRUs. The NEF may use weighting factors related to the ESI activation information, per ESI support, per energy saving level, per WTRU, and/or per group of WTRU, etc. For example, the NEF may have received from the AF an indication to select WTRUs from the WTRU list (e.g., a subset of ESI capable WTRUs), that are highly likely to be in active ESI state for time window 5:00 PM to 10:00 PM and highly likely to be in inactive state from 2:00 PM to 5:00 PM. In another example, the AF may indicate that it wants 30% of the WTRUs in the candidate WTRU list (e.g., a subset of ESI capable WTRUs) as highly likely not to activate the ESI in a specific future time window (e.g., between 5:00 PM and 10:00 PM), and 70% of the WTRUs in the candidate WTRU list as highly likely to activate ESI in the same future time window. In another example, the AF may indicate that it wants the NEF to select 40% of the WTRUs from the candidate WTRU list as WTRUs that are highly likely to use ESI level 1 in a future time window (e.g., between 5:00 PM and 10:00 PM), and 60% of WTRUs that are highly likely to use ESI level 2 in the same time window. In another example, the AF may indicate to the NEF to select 50% of WTRUs with short predicted duration for ESI active state, and 50% of WTRUs with medium to long predicted duration for ESI active state. The NEF may request different types of predictions and/or estimates from the EIF and/or NWDAF at 412. The NEF may use the different estimates to determine a final candidate WTRU list.

At 428, the NEF may send candidate WTRU list to the AF. The NEF may include an ESI category associated with each WTRU based on the determination in at 424.

What is claimed is:

1. A network device comprising:
a processor and memory, the processor configured to:
receive, from an application function (AF), a request for wireless transmit/receive (WTRU) selection assistance, an initial list of WTRU candidates, and energy saving indication (ESI) filtering criteria;
send, to a unified data management function (UDM), the initial list of WTRU candidates, and a request for information indicating one or more ESI capable WTRUs from the list of WTRU candidates, wherein an ESI capable WTRU is a WTRU candidate that has ESI information associated with its subscription data;
receive, from the UDM, a message indicating a plurality of ESI capable WTRUs from the initial list of WTRU candidates;
determine a subset of ESI capable WTRUs from the plurality of ESI capable WTRUs based on the ESI filtering criteria; and
send an indication of the subset of ESI capable WTRUs to the AF.

2. The network device of claim 1, wherein the processor is configured to:
receive, from a user plane function (UPF), information associated with a state of an ESI associated with a WTRU, a protocol data unit (PDU), session or a data flow associated with the WTRU;
determine an updated subset of ESI capable WTRUs based on the information associated with the state of the ESI; and
send the updated subset of ESI capable WTRUs to the AF.

3. The network device of claim 1, wherein the ESI filtering criteria comprises one or more of an indication of WTRUs currently in an ESI state, an indication of a ratio of WTRUs currently in an ESI active or ESI inactive state, an indication of percentage values of UEs currently under which ESI state to be selected, time value for a duration of a protocol data unit (PDU) session or data flow in an ESI state, or an indication of a ratio of PDU sessions, or data flows in an ESI state.

4. The network device of claim 1, wherein the request for WTRU selection assistance comprises an indication of an energy saving level.

5. The network device of claim 1, wherein the ESI capable WTRU is associated with a time value, wherein the time value represents the duration the ESI capable WTRU is subject to energy saving.

6. The network device of claim 1, wherein the ESI capable WTRU is associated with a location value, wherein the location value represents one or more geographic areas where the ESI capable WTRU is subject to energy saving.

7. The network device of claim 1, wherein the processor is further configured to:
send, to the AF, a notification message, wherein the notification message indicates that the initial list of WTRU candidates subject to energy saving or that the subset of ESI capable WTRUs is no longer valid or needs updating.

8. The network device of claim 7, wherein the notification message further indicates that the initial list of WTRU candidates subject to energy saving or that the subset of ESI capable WTRUs is no longer valid due to a change in the state of the ESI.

9. The network device of claim 1, wherein the message indicating a plurality of ESI capable WTRUs from the initial list of WTRU candidates further indicates one or more time validity conditions or one or more spatial validity conditions.

10. The network device of claim 1, wherein the network device comprises a network exposure function (NEF).

11. A method implemented by a network device, the method comprising:
receiving, from an application function (AF), a request for wireless transmit/receive (WTRU) selection assistance, an initial list of WTRU candidates, and energy saving indication (ESI) filtering criteria;
sending, to a unified data management function (UDM), the list of WTRU candidates, and a request for information indicating one or more ESI capable WTRUs from the list of WTRU candidates, wherein an ESI capable WTRU is a WTRU candidate that has ESI information associated with its subscription data;
receiving, from the UDM, a message indicating a plurality of ESI capable WTRUs from the initial list of WTRU candidates;
determining a subset of ESI capable WTRUs from the plurality of ESI capable WTRUs based on the ESI filtering criteria; and
send an indication of the subset of ESI capable WTRUs to the AF.

12. The method claim 11, further comprising:
receiving, from a user plane function (UPF), information associated with a state of an ESI associated with the WTRU or a protocol data unit (PDU) session or a data flow associated with the WTRU;
determining an updated subset of ESI capable WTRUs based on the information associated with the state of the ESI; and
sending the updated subset of ESI capable WTRUs to the AF.

13. The method of claim 11, wherein the ESI filtering criteria comprises one or more of an indication of WTRUs currently in an ESI state, an indication of a ratio of WTRUs currently in an ESI active or ESI inactive state, an indication of percentage values of WTRUs currently under which ESI state to be selected, time value for a duration of a protocol data unit (PDU) in an ESI state, or an indication of a ratio of PDU sessions, or data flows in an ESI state.

14. The method claim 11, wherein the request for WTRU selection assistance comprises an indication of an energy saving level.

15. The method claim 11, wherein the ESI capable WTRU is associated with a time value, wherein the time value represents the duration the ESI capable WTRU is subject to energy saving.

16. The method claim 11, wherein the ESI capable WTRU is associated with a location value, wherein the location value represents one or more geographic areas where the ESI capable WTRU is subject to energy saving.

17. The method of claim 11, wherein the processor is further configured to:
send, to the AF, a notification message, wherein the notification message indicates that the initial list of WTRU candidates subject to energy saving or that the subset of ESI capable WTRUs is no longer valid or needs updating.

18. The method of claim 17, wherein the notification message further indicates that the initial list of WTRU candidates subject to energy saving or that the subset of ESI capable WTRUs is no longer valid due to a change in the state of the ESI.

19. The method of claim 11, wherein the message indicating a plurality of ESI capable WTRUs from the initial list of WTRU candidates further indicates one or more time validity conditions or one or more spatial validity conditions.

20. The method of claim 11, wherein the network device comprises a network exposure function (NEF).
